(19) United States
(12) Patent Application Publication
(10) Pub. No.: US 2002/0083046 A1
(43) Pub. Date: Jun. 27, 2002

(54) Database management device, database management method and storage medium therefor

(76) Inventors: Hiroki Yamauchi, Shiga-ken (JP); Masashi Yamaguchi, Osaka-fu (JP)

Correspondence Address: MCDERMOTT, WILL & EMERY, 600 13th Street, N. W., Washington, DC, 20005-3096, US

(21) Appl. No.: 10/023,483

(22) Filed: Dec. 20, 2001

(30) Foreign Application Priority Data
Dec. 25, 2000 (JP) 2000-392661

(51) Int. Cl. G06F 7/00

(52) U.S. Cl. 707/1

(57) ABSTRACT

The invention has an object to provide a database management device, a management method, and the storage medium wherein data to be an object of searching in database can be searched in a short time while the exchanging can be smoothly executed between the data of which effective period expires and the data to be the following data.

The database management device, the management method, and the storage medium comprise the relevant information adding means for adding relevant information mutually associated with the data to both or either one of a specific data of which effective period expires and/or a following data corresponding to the specific data.

### BACKGROUND OF THE INVENTION

1. Technical Field

This invention relates to a database management device, a database management method, and the storage medium therefor, and more particularly, this invention relates to the database management device, the database management method, and the storage medium therefor wherein data have respective effective periods.

2. Description of the Related Art

The Internet applying the TCP/IP protocol plays a role as a research and educational network, and moreover it is utilized to the exchange of e-mail via Internet or Intranet between companies, and to the e-commerce and the electronic funds transfer via such network. It can be said that the Internet is the information communication infrastructure taking a role as a communication network between the society and individuals.

However, the Internet basically does not have a function of concealment and also prevent the falsification of communicating information so that it could be easy to tap and falsify the communicating information. Accordingly, It is very important that the security must be assured regarding the Internet communication including particular important information as well as in the private line.

As the technology for assuring the above security, for example, the security communication technology like the Virtual Private Network (VPN) has begun to attract notice; the VPN is a technology considering the Wide Area Network to be a Virtual Private Network. There is a tunneling protocol for carrying out the VPN, that is a connecting procedure of the security communication, that is to say, L2F (Layer 2 Forwarding), PPTP (Point-to-Point Tunneling Protocol), L2TP (Layer 2 Tunneling Protocol), ATMP (Ascend Tunnel Management Protocol), BayDVS (BayStream Dial VPN Service), and IPSEC (Internet Protocol Security Protocol) can be standardized. By using those protocols for the security communication, it is possible to assure the security of the communication on the Wide Area Network wherein the third party can tap the communication.

Among those technologies, the IPSEC is a security protocol performing the authentication and the encryption on the network layer (the third layer of the Open System Interconnection reference model), and is standardized by the Internet Engineering Task Force (IETF). The process of standardizing the Internet security protocol is as follows: first, in August 1995, the IPSEC protocol Version 1 was standardized as the IP protocol added with various security functions, and then in November 1998 the IPSEC protocol Version 2 was standardized as the IPSEC protocol Version 1 added with revisions and functional expansions together with the IKE protocol for the encryption and authentication key exchange.

Connecting with the Internet via a computer or a router of a network connector including the IPSEC function can configure the VPN. In other words, a user can utilize the Internet safely without considering a type of network. In addition, when a user starts to perform the communication utilizing the IPSEC, it is necessary to confirm in advance the matching regarding the type of authentication algorithm or encryption algorithm, the type of encryption key, and etc. between computers or network connectors including the IPSEC function on both a sending end and a receiving end. The intercommunication for the matching of the authentication algorithm or the encryption algorithm is called the connection for the security communication.

In IPSEC, the Security Association (SA) can carry out the connection. The SA includes information of the authentication algorithm, the encryption algorithm, the authentication key, and the encryption key for carrying out the security communication, and is a basic framework providing a function of both the authentication and the exchanging of secured messages, which defines the some aspects of the security for the communication.

The conventional method employing IPSEC as the security communication is explained as follows according to FIGS. 9, 10, 11 and 12. A communication terminal in this explanation may include a network connector and a computer.

FIG. 9 shows a block diagram of a conventional network system configuring the VPN network by using routers including the IPSEC function as the conventional security communication. FIG. 10 is a diagram showing the connecting procedures for the security communication between network connectors including the IPSEC functions. FIG. 11 shows an example of Security Policy Database (SPD) in the prior arts determining the processing policy of the IPSEC. FIG. 12 shows an example of Security Association Database (SAD) in the prior arts. The SPD is a database comprising the security policy. The security policy means the regulations of accessing to a system in which the security is assured, which generally includes security requirements, risks of the security, and security measuring means. In case where a system assures the security between the communication terminals, the SPD is provided with information for distinguishing the communication terminal of destination employing the security and for determining whether the security should be applied to the communication or not. In IPSEC, the security policy is described on the SPD. The SA is descriptive of the contents of the security policy, such as IP address of communication terminal on a receiving end, whether the IPSEC processing was performed or not, and the content of the authentication algorithm or the encryption algorithm. The SPD is provided with the address information on the memory wherein the above SA is stored.

In FIG. 9, a computer 901 is connected with other computer 905 and a network connector 902 via Local Area Network (LAN) 907, while being connected with an external Internet 909 or WAN such as Intranet passing through the network connector 902. The Internet 909 is connected with LAN 908 connected with computers 904 and 906 via other network connector 903. The network connectors 902 and 903 are a firewall or an apparatus dedicated for VPN, such as a router, a gateway, or a proxy server. The computer 901 and others in this system may be a terminal including a communication function like a personal computer, a workstation, a server, a notebook-sized personal computer, an IP phone, an IP TV-phone, or an IP mobile phone.

Supposed that the network connectors 902 and 903 include the IPSEC function and the communication based on IPSEC is performed between them. But, if the computers 901 and 904 include the IPSEC function, it is also possible to carry out the communication based on IPSEC between them. Moreover, it is also possible to carry out the communication base on IPSEC between the computer 901 including the IPSEC function and the network connector 903 including the IPSEC function.

When the computer 901 sends data to the computer 904 via Internet 909, it is necessary to perform in advance the connecting between the network connectors 902 and 903 for the security communication. The connecting for the security communication is explained as follows.

Before starting the IPSEC communication, Internet Key Exchange (IKE) is employed as a protocol for exchanging the encryption key of IPSEC. The communication using IKE can be explained by dividing an IKE phase 1 and an IKE phase 2, which is performed between the network connectors 902 and 903. It may be arranged that the secret key be exchanged in manual without using the automatic key exchanging of IKE.

The IKE phase 1 (FIG. 10: S1001) exchanges the information to establish the mutually available SA in order to perform the safe communication of IKE itself. The SA means here a series of groups of definition information including the authentication algorithm, the authentication parameter, the encryption algorithm, the encryption parameter and so on.

Next, the IKE phase 2 (FIG. 10: S1002) exchanges the information about the SA for IPSEC communication according to the SA established by the IKE phase 1. An example of the SA for the IPSEC communication is shown in FIG. 12. FIG. 12 shows SAD 1201, which is a plurality of SA, includes SA1 (1202) to SAM (1204). Each SA includes sending host address 1205, receiving host address 1206, protocol 1207, SPI (Security Parameter Index) 1208 as index information of SA, registration time 1209, effective period 1210, update waiting period 1211, authentication algorithm 1212, authentication key 1213, encryption algorithm 1214, and encryption key 1215.

The sending host address 1205 includes an IP address of and a port number of sending end, the receiving host address 1206 includes an IP address and a port number of destination, and the protocol 1207 includes a protocol number. In addition, the SPI 1208 adopts the pseudo random numbers, and so on, which can specify the SA.

The registration time 1209 stores the time the SA is registered, the effective period 1210 stores the effective time of the SA, and the update waiting period 1211 stores the period until the time the SA is to be updated. The details will be described later.

Moreover, the authentication algorithm 1212 stores a type of authentication algorithm, HMAC-MD5-96, for example. The encryption algorithm stores a type of encryption algorithm, DES-CBC, for example. The authentication key 1213 and the encryption key 1215 store keys required for the authentication or the encryption (decryption) respectively.

Exchanging information about the SA for the IPSEC communication is performed by the IKE phase 2 (S1002), which is explained in the concrete. The network connector 902 sends to the network connector 903 the proposal components of the SA to be applied to the IPSEC communication, in response to this the network connector 903 sends back acceptable SA among the proposals. At this time, the proposal components of the SA comprise the authentication algorithm, the encryption algorithm and the like previously stored in data storage of the network connector 902. The type of the authentication algorithm or the encryption algorithm included in the network connector 902 depends on the kind of network connector. Besides, it is possible to predetermine the SA that the network connector 902 is to propose.

According to the above replay of the SA, the SA to be applied to the IPSEC communication is established. The information of the established SA to be applied to the IPSEC communication is stored in SAD 1201 in FIG. 12 and SPD 1101 in FIG. 11. The configuration of SPD 1101 is as follows: the receiving host address 1102, whether the IPSEC processing was performed or not 1103, address pointer 1104 indicating the position of each SA in the SAD 1201, and IP address 1105 of the communication terminal of destination to which the IPSEC packet is sent in case of sending data to the receiving host address 1102. At this time, the IP address 1105 is IP address of the network connector 903 specifically. When the communication terminal of destination includes the IPSEC function, the IP address 1102 gets to be the same as the above IP address 1105. Additionally, it is possible to designate the range regarding the receiving host addresses 1102 and the IP address 1105. The range designation means to designate from “192.168.1.1. to 192.168.1.100” by using the IP addresses, thereby one time of the range designation can instruct to send data to 200 units of communication terminals. As one of the SA is set by the unidirectional communication, in case of the bi-directional communication an independent SA is set on the network connectors 902 and 903 respectively.

After establishing the SA to be applied to the IPSEC communication, the computer 901 adds IP header to the data sent from the computer on sending end 901 to the computer 904 and then sends it as IP packet toward the network connector 902 via LAN 907. The network connector 902 performs the IPSEC processing, which is described later, and thereby sends the IP packet as IPSEC packet 1003 toward the network connector 903. The network connector 903 that has received the IPSEC packet 1003 converts the IPSEC packet to IP packet by the IPSEC processing, which is sent to the computer 904 via LAN 908. Accordingly, on the communication between the network connectors 902 and 903 connected each other via Internet 909, the IPSEC can assure the security of the data sent from the computer on the computer 901 of the sending end to the computer 904.

Referring to FIGS. 9, 13 and 14, here is explained in detail about the IPSEC processing performed by the network connectors 902 and 903. Since the processing varies according to the device structure or the adopted method, here is explained about one of examples. FIG. 13 is a flowchart of the IPSEC processing of the network connector on the sending end, and FIG. 14 is a flowchart of the IPSEC processing of the network connector on the receiving end. Besides, SPD and SAD, which are explained later, are stored in the data storage of the respective network connectors. Here, “S” shown in FIGS. 13 and 14 means a Step of the processing.

When receiving the IP packet sent from the computer 901 on the sending end, the network connector 902 reads the receiving host address (FIG. 13: S1301). According to the receiving host address, the network connector 902 searches the receiving host address 1102 of the SPD 1101 stored in the network connector 902, and then reads out the information of the communication terminal to which the corresponding IPSEC packet is sent: the IP address, whether the IPSEC processing was performed or not 1103, and address pointer 1104 indicating the position of each SA in the SAD 1201 (FIG. 13: S1302).

In case where the IPSEC processing is not performed, that is to say, when “whether the IPSEC processing is performed or not” 1103 is NO, the received IP packet is sent to the network connector 903 without the processing (FIG. 13: S1303-No).

In case where the IPSEC processing is performed, that is to say, when “whether the IPSEC processing is performed or not” 1103 is YES, after searching the SAD 1201 according to the address pointer 1104 indicating the position of the SA, the network connector 902 reads the content of the corresponding SA (Fig.13: S1303-YES to S1305). The SA has been established by the IKE phase 2 (FIG. 10: S1002). Next, according to the content of the SA, for example, the network connector 902 prepares the authentication/encryption data based on the IP packet by using HMAC-MD5-96 as the authentication algorithm and DES-CBC as the encryption algorithm (FIG. 13: S1305). In addition, the network connector 902 adds to the authentication/encryption data with an authentication header AH (authentication header) or an authentication/encryption header ESP (Encapsulation Security Payload), which data changes to be an IP packet (IPSEC packet 1003) processed by the IPSEC processing (FIG. 13, S1306).

The AH and the ESP includes the SPI 1208 composing the SA established by the IKE phase 2. Subsequently, the IPSEC packet 1003 is sent to the network connector 903 indicated by the IP address 1105 of the SPD 1101 via Internet 909.

On the next step, the network connector 903 determines whether the received IP packet is an IPSEC packet or not (FIG. 14: S1401).

However, when the received IP packet is not an IPSEC packet, the IP packet is sent to the computer 904 via LAN 908 without the processing (FIG. 14: S1401-No).

On the other hand, when the received IP packet is an IPSEC packet, the following processing is performed (FIG. 14: S1401-Yes). That is to say, the network connector 903 first searches the AH or the ESP header in the IPSEC packet, and reads the SPI included in the AH or ESP header (FIG. 14: S1402). Next, the network connector 903 searches the SAD stored in the network connector 903 according to the SPI, and then reads the content of the SA corresponding to the SPI, the SA was established by the IKE phase 2 (FIG. 14: S1403). Thereby, the SA established by the IKE phase 2 can be read out. However, if there is no corresponding SPI on the step of S1402, the massage with that meaning is displayed for a user and then the processing terminates (which is not shown in the drawing).

Additionally, the network connector 903 authenticates/decrypts the authentication/encryption data of the IPSEC packet according to the authentication/encryption algorithm specified by the readout SA (FIG. 14: S1404). If necessary, the network connector 903 searches the SPD 1101 according to the address information 1104 of the SA, and confirms the IP address of the sending-end host and whether the IPSEC processing is performed or not, thereby it is possible to prepares the original IP packet (FIG. 14: S1405 to S1406). Subsequently, the network connector 903 sends the prepared IP packet to the computer 904.

As explained above, the above authentication/encryption data of the authenticated/decrypted IPSEC packet is sent as an IP packet to the computer 904 via LAN 908. Therefore, on the communication between the network connectors 902 and 903, it is possible to assure the security by IPSEC regarding the data sent from the computer 901 on the sending end to the computer 904.

The above description refers to the detailed processing about the IPSEC. In addition to the above processing, in order to carry out more concealed communication, the following processing are performed. That is to say, the SA 1202 to 1204 are provided with an effective period called “lifetime”.

For instance, in case of a long time communication between specific terminals, it may allow the third party to tap the information of the communication and give them a time enough to analyze the communicating information. Accordingly, it raises the possibility of the leak of information. In such case, the SA is provided with an effective period and at specific time intervals a new SA is to be established again, thereby it can raise the concealment.

Specifically, as shown in FIG. 15, SA 1(1501) is provided with an effective period like a specific time (8 hours, for example). Information of the effective time is stored in the effective period 1210 shown in FIG. 12. Time 1502 established (prepared, registered) by the SA 1(1501) is stored in the registration time 1209. According to the registration time 1209 and the effective period 1210, the termination time 1503 for which the SA 1(1501) should be applied to the communication is determined. That is to say, after the effective period of the SA 1(1501) expires, SA 5(1504) may be utilized to the communication with the corresponding communication terminal instead of the SA 1(1501), for example.

However, since establishing the SA 5(1504) requires the abovecomplicated procedures by means of IKE, it requires a few times 1505. Accordingly, the update waiting period 1211 stores time 1506 from the termination time 1503 or time 1507 from the establishment of SA 1(1501). Thereby, the processing for establishing SA 5(1504) starts from time 1508 indicated by the update waiting period 1211.

Besides, after establishing a new SA 5(1504), the old SA 1(1501) will not be deleted from the SAD until the effective period expires.

As described above, by means of the above IPSEC, for example, it is possible to carry out more concealed communication. However, the above processing, particularly the process of searching SA described in S1403 of FIG. 14 will be executed basically every time at sending and receiving a packet. The bottleneck processing in IPSEC in the prior arts is the encryption/decryption and the authentication. But making such processing hardware has been improved recently, and such bottleneck tends to be settled. Thereby, the searching of the above SAD becomes a next coming bottleneck processing. Particularly, due to the increase of communication volume via network and the increase of packet processing volume of each terminal, the influence comes to be appeared remarkably. Moreover, in a basic router gathering up connections, the influences become aggravated.

Additionally, the effective period of the SA can be examined by only the SA searching when the packet corresponding to the SA is inputted or outputted. Therefore, if the effective period of the SA has expired during the interruption of the input-output of packets, such effective period cannot be detected. Where the effective period of the SA has expired while the communication is interrupted temporarily, the sending and receiving ends must establish the SA at restarting the communication. It is a problem that the communication cannot be restarted quickly.

In case of the long-playing real-time video communication (streaming communication) by means of IPSEC protocol, it happens that the effective period of SA expires in the middle of the communication so that IKE must establish a new SA in the middle of the communication and the new SA is to be effective. However, since the network like the Internet utilizes an unspecified communication route, for example, the arrival order of packets is not always assured. Therefore, it causes the following case: even though the SA of the receiving end has a new SA, the receiving end happens to receive a packet applying the old SA.

When such state is generated, the difference between the times for searching in the new SA and for searching in the old SA, those SA are in the SAD, causes to generate blanks or disturbance of received video.

Additionally, where a packet is outputted from the sending end just before the termination of the effective period, the following problem appears: when the packet arrives at the receiving terminal, the effective time of the SA has expired, therefore the packet is abandoned.

### SUMMARY OF THE INVENTION

Therefore, the invention has an object to provide the database management device, the database management method and the storage medium, wherein the database includes an effective period, and the data to be an object of searching within the database can be searched in a short time while the data expiring the effective period and the following data can be exchanged smoothly.

In order to achieve the above object, the invention comprises the following means.

Provided that a database management device manages information comprising required matters including an effective period as one data unit and prepares following data corresponding to the data when the effective period of the data expires. And relevant information adding means adds relevant information mutually associated with the data to both or either one of a specific data of which effective period expires and/or a following data corresponding to the specific data.

In result, even where data of one side is searched, it is possible to read relevant data of other side at once. Accordingly, it is possible to improve the speed of searching object data, and also to reduce the loads of the database management device.

Relevant information searching means searches corresponding data referring to the relevant information including the data at the time of referring to the specific data or the following data.

Effective period management means stores the effective period and the reference information of data including the effective period associating each other, and notifies of the expiration when the effective period expires. Data control means performs on the data specific processing due to the expiration of the effective period at receiving the notice from the effective period management means. The specific processing is to prepare the corresponding following data, and to delete the data of which effective period expires.

In the above configuration, it is possible to be sure to perform the necessary processing such as the preparation of data, the deletion of the registration, and the like. Since the necessary processing can be sure to be performed, it is possible to avoid the descent of the speed of searching due to leaving the unnecessary data and the waste of the storage area.

In case where the information containing the required matters includes the time information to prepare the following data before the effective period expires, update management means stores the time information and the reference information of data including the time information associating each other and notifies to the effect that the time indicated by the time information has come. At receiving the notice, the following data is prepared. In this configuration, the invention may be provided with relevant information adding means for adding the relevant information associated with the data each other to both or either one of a specific data of which effective period expires and/or the following data corresponding to the specific data.

By managing the update start time accurately, it is possible to be sure to prepare and register the following data. Since the sufficient time is set as the update waiting period, either one of the data or the following data can always exist in the sate of validity. Therefore, it is possible to be sure to do away with the delay of the preparation of data and of the communication for registration.

In addition, it may be arranged that effective period extension means store the extension period information to extend the effective period and renew the effective period of data of which effective period expires to the period indicated by the extension period information when the effective period expires, and searching order management means set the searching order of the following data in front of the data corresponding to the following data.

By comprising the effective period extension means, it is possible to make efficient use of the data (packet) to be abandoned originally.

Searching frequency monitoring means monitors the searching frequency of the following data and the data corresponding to the following data, and the searching order management means changes the searching orders of the specific data and the following data according to the searching frequency.

Under this configuration, within the period for which both of the following data and the data corresponding to the following data, either one of data, of which the searching frequency is higher than the other, is to be set as in order in which the searching time is short, thereby the data with high searching frequency can be searched in a short time.

The data may be information to carry out the security communication on a network, and the effective period is one of the information to carry out the security communication.

Particularly, in case where the data have to be transmitted consecutively like the long-playing real-time video communication (streaming communication) by means of IPSEC protocol and a specific level of the security has to be assured, even if the information to carry out the security changes, it does not cause any affection of the playback of the streaming data.

The information to carry out the security communication can contain either one of an authentication algorithm, an encryption algorithm, an authentication key, or an encryption key.

The data can be SA (Security Association) applied to the IPSEC (Internet Protocol Security Protocol), too.

### BRIEF DESCRIPTION OF THE DRAWINGS

FIG. 1 is an image view showing an outline of a database management device and SAD of the invention.

FIG. 2 is a block diagram of hardware of a network connector storing the database management device of the invention.

FIG. 3 is a flowchart showing the processing of the database management device of the invention.

FIG. 4 is an image view showing an outline of a database management device and SAD in the embodiment 2 of the invention.

FIG. 5 is a diagram showing the status of SA corresponding to the time axis.

FIG. 6 is an image view showing an outline of a database management device and SAD in the embodiment 3 of the invention.

FIG. 7 is an image view showing an outline of a database management device and SAD in the embodiment 4 of the invention.

FIG. 8 is an image view showing an outline of a database management device and SAD in the embodiment 5 of the invention.

FIG. 9 is a block diagram of a network system using a router installing the conventional IPSEC function.

FIG. 10 is a diagram showing the procedure of connecting network connectors installing the IPSEC function.

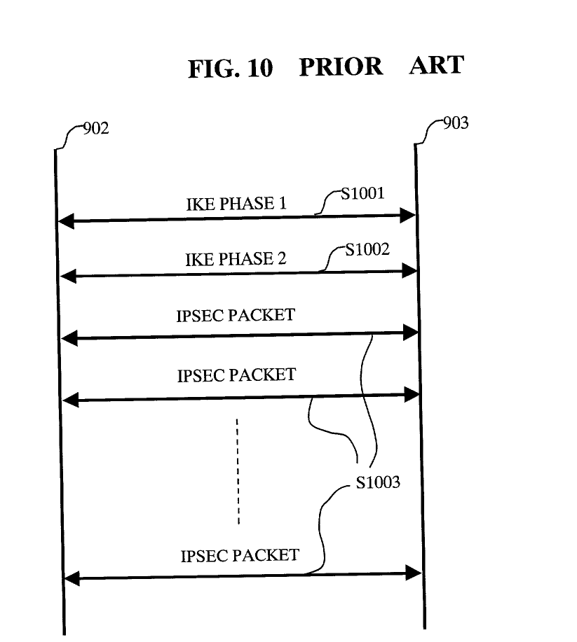

FIG. 11 is an example of SPD (Security Policy Database) in the prior arts.

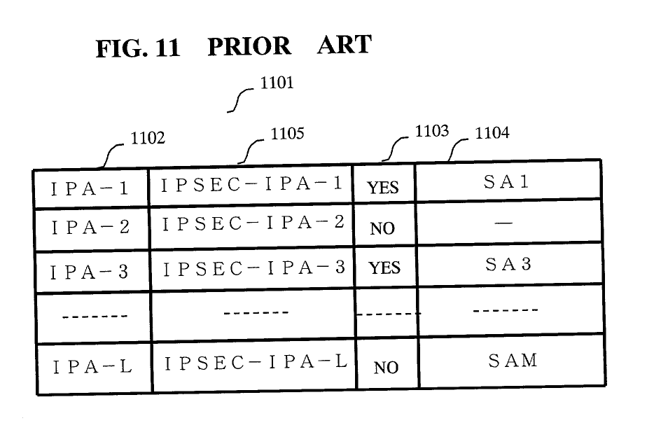

FIG. 12 is an example of SAD (Security Association Database) in the prior arts.

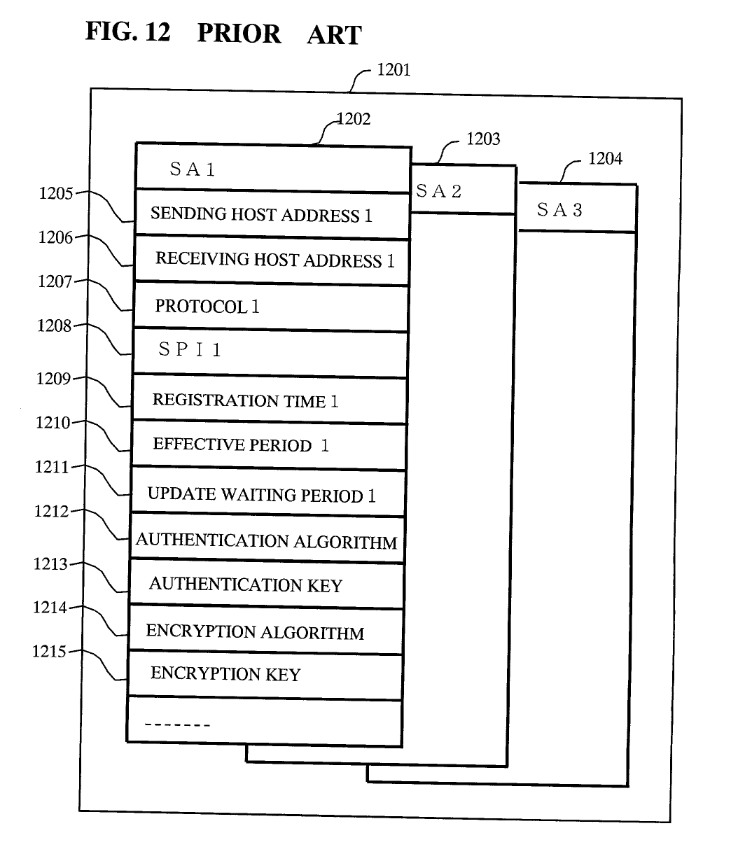

FIG. 13 is a flowchart of IPSEC processing of a network connector on the sending end.

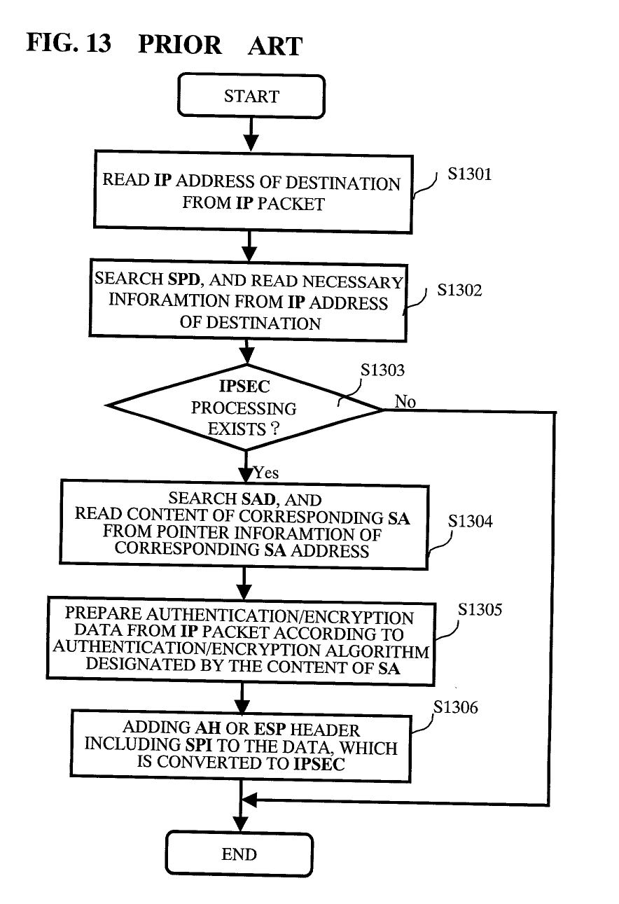

FIG. 14 is a flowchart of IPSEC processing of a network connector on the receiving end.

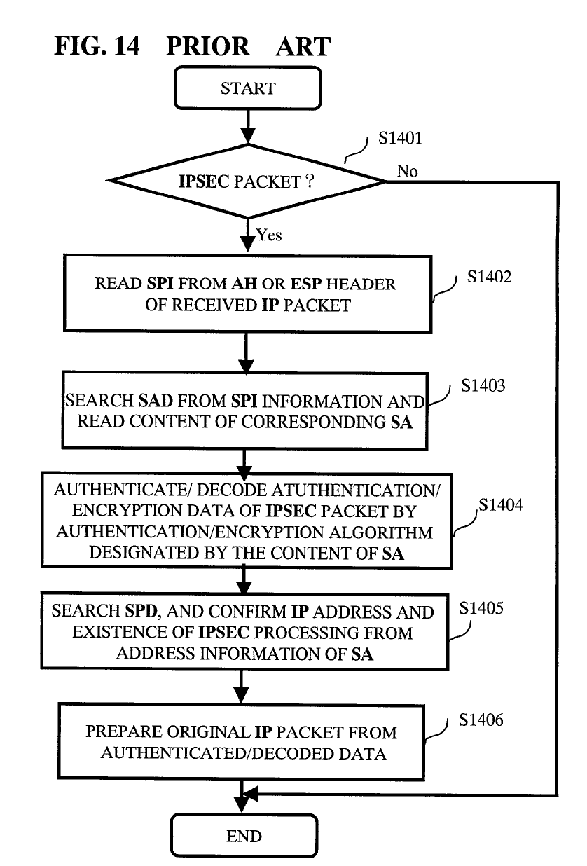

FIG. 15 is an image view explaining the status of SA corresponding to the time axis.

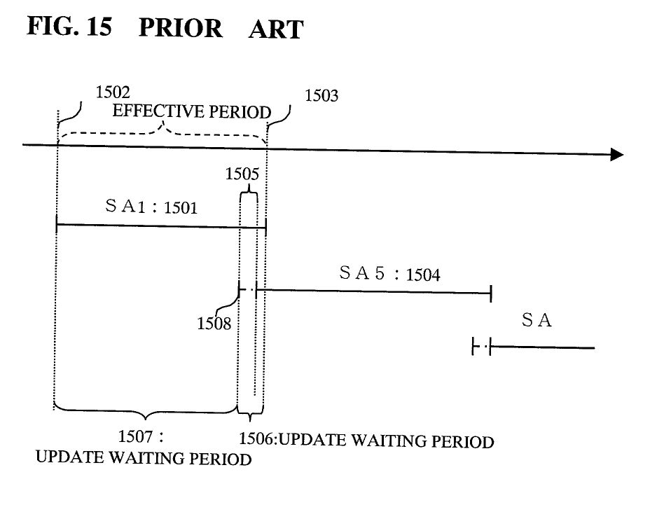

### DETAILED DESCRIPTION OF THE INVENTION

The preferred embodiments of the invention will be explained hereinafter referring to the attached drawings, and be offered in order to understand the invention. Besides the following embodiments are no more than examples of the materialized invention, and do not restrict the scope of the technical field of the invention.

### EMBODIMENT 1

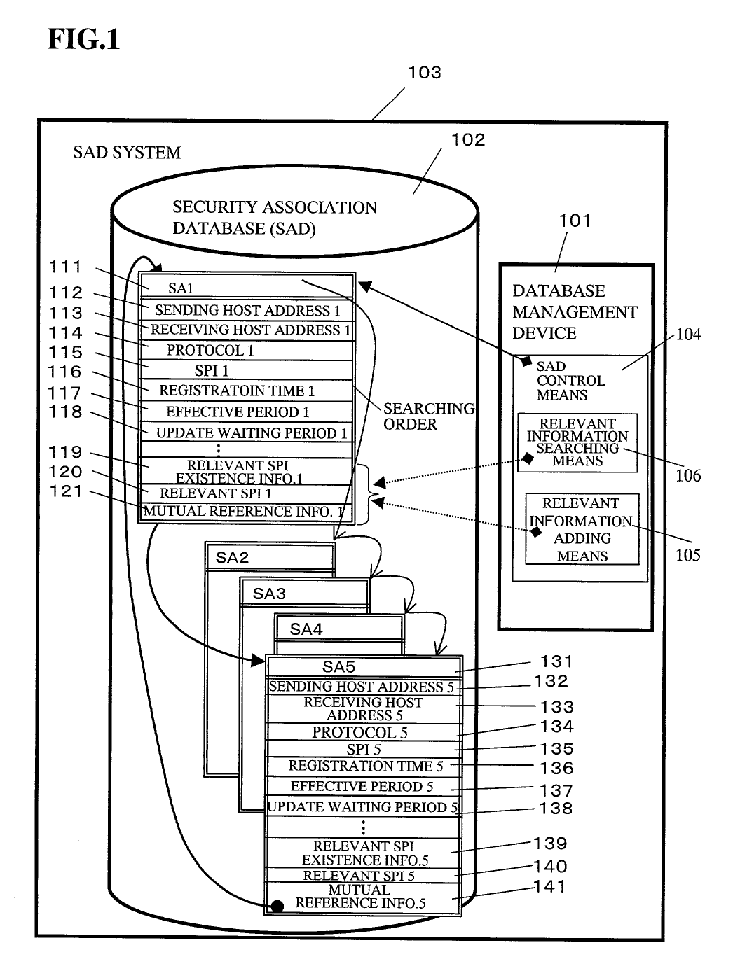

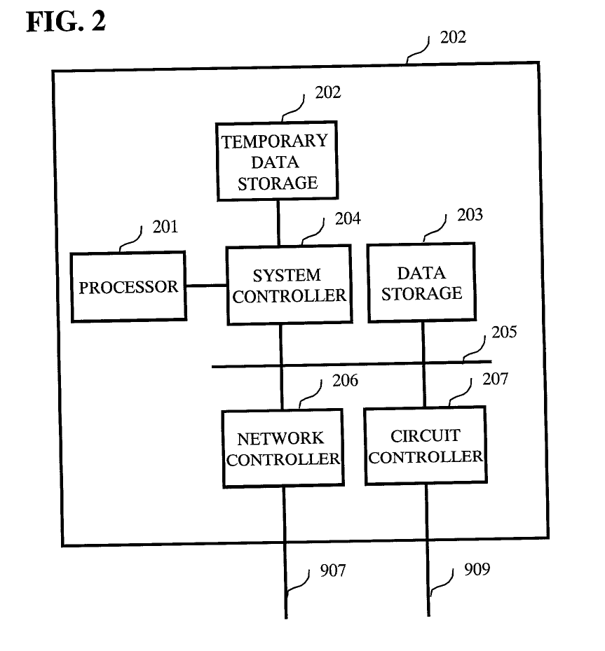

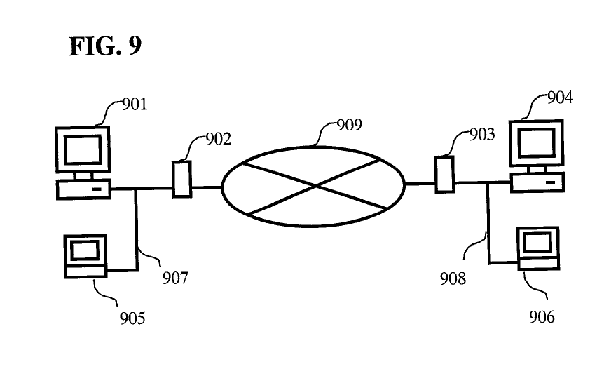

First of all, according to FIG. 1, FIG. 2 and FIG. 9, the configuration of a database management device in the embodiment 1 is explained here. Besides, the database management device 101 is the network connector 902 (903) or the computer 901 shown in FIG. 9, and is provided in a terminal including IPSEC function, for example. The network configuration is explained according to the same as that of the prior art shown in FIG. 9.

The network connectors 902 and 903 are generally configured as shown in FIG. 2. That is to say, processor 201, temporary data storage 202, data storage 203, system controller 204, network controller 206, and circuit controller 207 are connected with each other by an internal bus or a switch 205 respectively. The network controller 206 is connected with LAN 907, and the circuit controller 207 is connected with Internet 909. Besides, the each network connector 902 and 903 in the embodiment 1 is provided with a network controller 206 and a circuit controller 207, but the network connector may be configured so as to be provided with a plurality of network controllers 206.

The SPD and SAD mentioned in the prior art are stored in the data storage 203 configured by a non-volatile memory such as a flash memory, a hard disk, ROM, or the like. The processor 201 reads the SPD and the SAD from the data storage 203 passing through the system controller 204 when the network connector 902 is powered up, and stores them in the temporary data storage 202 configured by the volatile memory such as DRAM and SRAM. Otherwise, the processor 201 reads the SPD and SAD on demand and then stores them in the temporary data storage 202. In case where the update is performed for the SPD and the SAD, it may simply update those stored in the data storage 203 and the temporary data storage 202.

Specifically, the database management device 101 shown in FIG. 1 is carried out by the processor 201 and can be provided as software or hardware, for example. In addition, the SAD 102 is stored in the data storage 203, the temporary data storage 202, or the like. Therefore, the SAD system 103 is configured by the processor 201, the data storage 203 and/or the temporary data storage 202.

Regarding each IP packet (IPSEC packet) received from the LAN 907 or the Internet 909 passing through the network controller 206 or the circuit controller 207, the processor 201 performs the IPSEC processing as described in the prior arts. That is to say, the processor 201 reads out the AH and ESP information of each IPSEC packet and searches the required data in SPD and SAD stored in the temporary data storage 202 according the above-mentioned processing flow. In addition, after performing the authentication/encryption or the authentication/decryption for the IPSEC, the processor 201 sends them to the address of destination. The other functions (the routing function, and so on) can be provided by the processor 201.

The reason for searching the SPD and SAD stored in the temporary data storage 202 at the processing of each IP packet is that it is possible to access to the temporary data storage 202 speedier than to the data storage 203, thereby it is possible to advance the speed-up of the IPSEC processing.

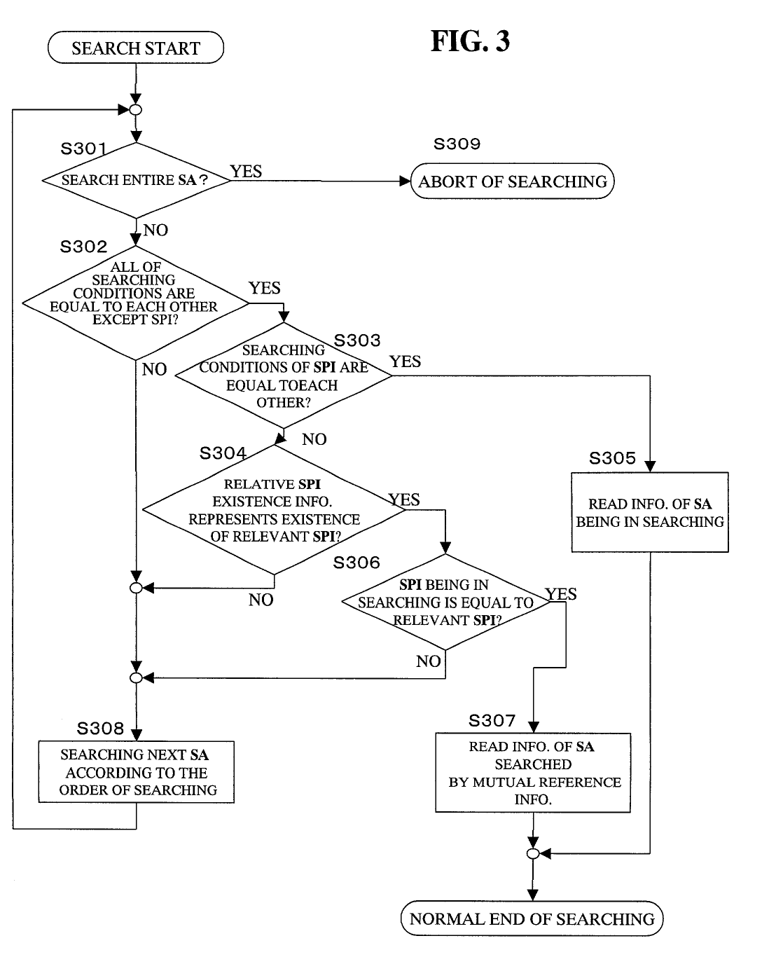

Next, the processing executed by the database management device 101 of the embodiment 1 is explained in detail according to FIG. 1 and FIG. 3.

The SAD control means 104 composing the database management device 101 performs the various setting of SA; the deletion and the exchange within the effective period, the insertion at the time of update starting; the searching, and the setting of the searching elements. The details of those setting will be described later. Besides, the above processing show no more than an example, and the other processing may be executed by the SAD control means 104.

Elements (required matters) of each SA in the SAD (SA1 to SA5 shown in FIG. 1) are sending host address 112, receiving host address 113, protocol 114, SPI 115, registration time 116, effective period 117, update waiting period 118, relevant SPI existence information 119, relevant SPI 120, and mutual reference information 121. Besides, those elements of the SA are shown as one of examples, and the SA may contain the authentication algorithm 1212, the authentication key 1213, the encryption algorithm 1214, the encryption key 1215 and the like as described in the prior arts, or may not contain unnecessary elements of the prescribed elements.

The above configuration is a base of the SAD system 103 dealt by the embodiment 1.

The following explanation refers to a case where SA5 (131) becomes SA instead of SA1 (111) of which effective period has expired. The order of searching each SA in the SAD should be determined by the order of the preparation of SA or by the order of addresses in the storage are storing the SA, for example. Besides, the management of the expiration of effective periods is not important subject in the embodiment 1, the explanation of which is to be left out.

First of all, the database management device 101 prepares SA5 (131) that becomes a following SA instead of SA1 (111) of which the effective period expires or comes near to the expiration. Besides, the SA5 (131) is to be prepared after determining the required matters to be stored in the SA5 by communicating with an opposite communication terminal by the IKE protocol. At this time, relevant information adding means 105 composing the database management device 101 adds the relevant SPI existence information 119, the relevant SPI 120 and the mutual reference information 121 to the SA1 (111).

The relevant SPI existence information 119 stores a flag representing whether the relevant (that is to say, a following SA,) SA5 (131) exists or not, in other words, the after mentioned relevant SPI 120 and mutual reference information 121 are “valid” or “invalid” respectively. Until preparing the SA5 (131), the relevant SPI existence information 119 stores information representing “invalid”. Meanwhile, the relevant SPI 120 stores SPI 135 stored in SA5 (131), while the mutual reference information 121 stores address information of the SA5, that is to say, a pointer indicating an address of a field storing SA5.

In addition, regarding the SA5 (131), the relevant SPI existence information 139 stores whether the relevant SA1 (111) exists or not, that is to say, a flag representing that the relevant SPI 140 and the mutual reference information 141 are “valid” or “invalid”. And the relevant SPI 140 stores SPI 115 stored in the SA1 (111), while the mutual reference information 141 stores a pointer indicating the address of the SA1 (111).

Therefore, according to the relevant SPI existence information 119, 139, the relevant SPI 120,140, and the mutual reference information 121, 141, the position of SA5 (131) can be read out immediately when the SA1 (111) is detected by the SAD control means 104, while the position of SA1 (111) can be read out immediately when the SA5 (131) is detected by the SAD control means 104, for example.

Next, the procedure of searching in SAD 102 by the database management device 101 will be described hereinafter according to FIGS. 1 and 3.

The SAD control means 104 searches SA in SAD 102 in sequence on demand at sending/receiving the packet, and when an object SA is found out, the content is read out. This embodiment refers to an example of the procedure up to reading out the SA5 (131) in case of inputting the IPSEC packet applying SA5 (131), for example.

According to the header information of the IPSEC, the receiving host address, the protocol, and the SPI are extracted as searching conditions. And after confirming whether the entire SA in the SAD was searched, if the searching of the entire SA was completed, the searching aborts (FIG. 3: S301 YES to S309).

Regarding the processing of confirming whether the entire SA was searched, if there is still any SA without being searched, the following processing is executed (FIG. 3: S301 NO to S302).

In the next step, the receiving host address and the protocol that were extracted as above are compared with the receiving host address 113 and the protocol 114 in the SA1 (FIG. 3: S302).

However, if the extracted receiving host address and protocol are not agreed with the receiving host address 113 and the protocol 114 in the SA1, the searching in a next SA is executed (FIG. 3: S302 NO to S308 to S301).

When the extracted receiving host address and protocol are agreed with the receiving host address 113 and the protocol 114 in the SA1, the extracted SPI is compared with SPI 115 of SA1 (111) additionally (FIG. 3: S302 YES to S303).

Where the extracted SPI is equal to SPI 115 of the SA1 (111), the IPSEC packet is determined to be the object SA. After reading out the content of the SA, the searching ends (FIG. 3: S303 YES to S304).

Besides, since SA5 (131) is the object to be searched here, the extracted SPI is not agreed with the SPI 115. Accordingly, the content of the relevant SPI existence information 119 is to be confirmed in the next place (Fig.3: S303 NO to S304).

Next, when the relevant SPI existence information 119 does not represent the existence of the relevant SPI, that is to say, the content is “invalid”, and then the searching of the next SA is executed (FIG. 3: S304 NO to S308 to S301). The “invalid” indicates that there are no following SA, and a case where the communication is normal and SA1 (111) has an enough effective period.

Where the relevant SPI existence information 119 represents the existence of relevant SPI, that is to say, the content is “valid”, and then the extracted SPI is compared with the relevant SPI 120 in SA1 (111) (FIG. 3: S306 YES to S306).

Where the extracted SPI is different from the relevant SPI 120 in the SA1 (111), the SA1 (111) is determined not to be relevant to SA5 (131). And then the searching of the next SA is executed (FIG. 3: S306 NO to S308 to S301).

If the extracted SPI is equal to the relevant SPI 120 of the SA1 (111), this means that the SA1 (111) has a following SA and the reference information of the following SA is stored in the mutual reference information 121, thereby the SA5 (131) is determined by the reference information (pointer) stored in the mutual reference information 121 (FIG. 3: S306 YES to S307). Subsequently, information comprising required matters stored in the SA5 (131) are read out and then the searching ends normally (FIG. 3: S307 to normal end of searching).

The required matters to be stored in each SA are read out by the above processing and applied to the decryption of the encryption of the IPSEC packet, which are the same as in the conventional prior arts. The processing of referring to the relevant SPI existence information, the relevant SPI, and the mutual reference information (S304, S306, and S307) are executed by the relevant information searching means 106 comprising the SAD control means 104.

As described above, if the SA1 is not an object to be searched, the searching in the conventional prior arts has to be executed in the following order, SA2, SA3, for example. However, respective data are provided with the relevant information between data, such as the relevant SPI existence information, the relevant SPI, the mutual reference information and the like, thereby when the one side of data is searched, the other side of data relevant to this can be read out at once. Therefore, it is possible to improve the speed of searching an object SA and reduce the load of the database management device. In conclusion, even when it is necessary to transmit data consecutively for hours by the real time video communication and it is necessary to ensure the security to a specific level, it does not interfere with the playback of streaming data by changing information necessary to carry out the security because the searching of the SA is executed at high speed.

Besides, the invention is arranged in the embodiment 1 that the relevant information of SA contains three, the relevant SPI existence information, the relevant SPI and the mutual reference information. However, the relevant information may be arranged so as to include other information or the unnecessary information that is not always required. Although the invention in this embodiment applies the address (pointer) of storage area to the method of referring from SA to the relevant SA, an entry number of data managed by the database may be used to the method.

The SA searching procedure described above adopts the receiving host address and the protocol as the searching condition except SPI, but a priority processing flag of packet (“Type of Service” field in IPv4, or “Flow Label” field in IPv6) may be added to those as the searching condition, if necessary, the other information may be added.

### EMBODIMENT 2

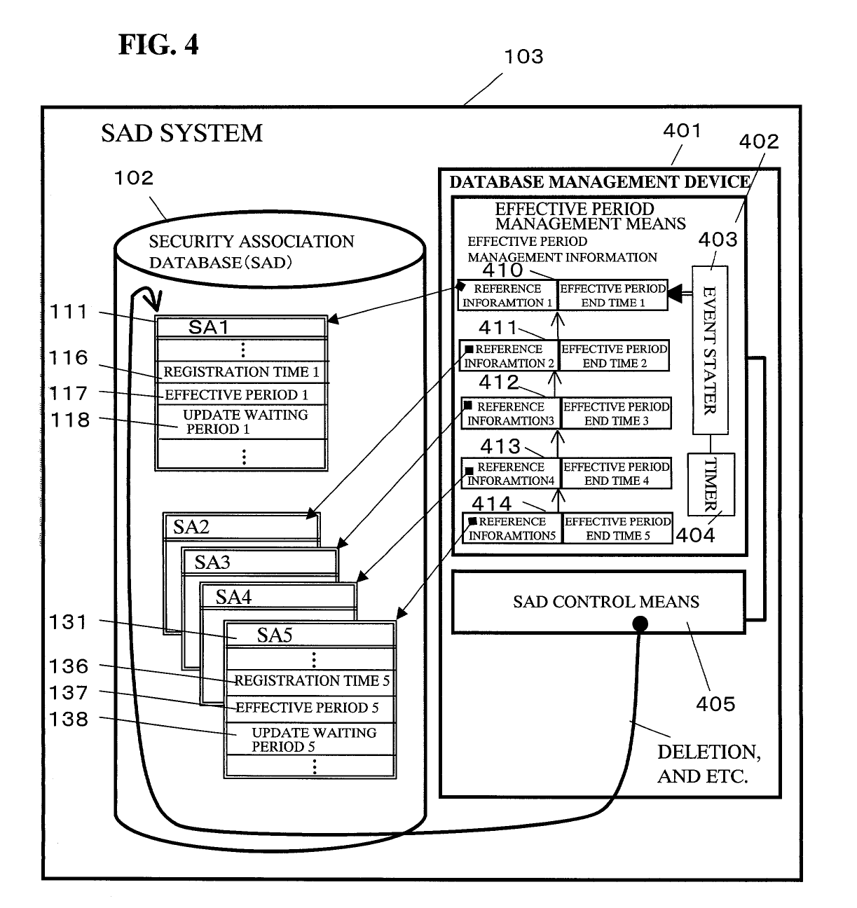

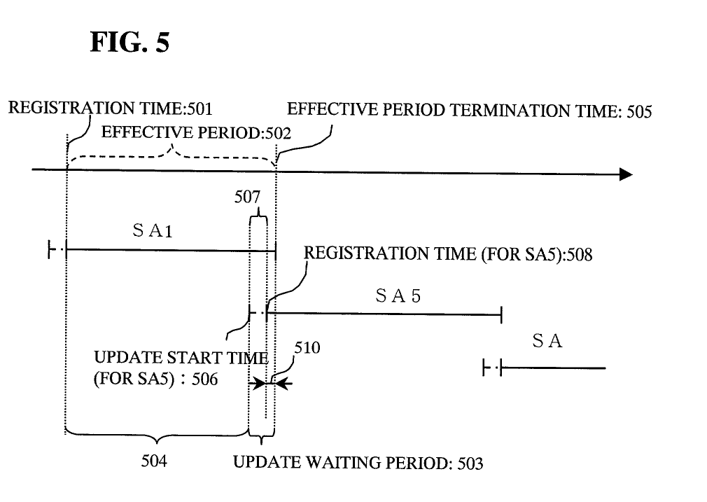

The following explains about the configuration of the database management device 401 in the embodiment 2 according to FIGS. 4 and 5. Besides the database management device 401 in this embodiment shares many parts with that in the embodiment 1, so that only the different parts are explained here. Each SA stored in the SAD 102 (SA1 to SA5 in this embodiment) stores the registration time 116, 136, the effective period 117, 137, and the update waiting period 118, 138, respectively. However, for instance the relevant information described in the embodiment 1 are not always required, such as the relevant SPI existence information, the relevant SPI, the mutual reference information, and so on. And the update waiting period 118, 138 are not always required, too. The registration time 116 of the SA1 (111) here stores a value of the registration time 501 the SA1 (111) was prepared. The effective period 117 stores the effective period 502 during which the SA1 (111) can be available for the communication. The update waiting period 118 stores a time (update waiting period 503 in FIG. 5) including the time (505) for preparing a following SA by the IKE protocol added with sufficient time to some extent. Besides, the registration time 116, the effective period 117, and the update waiting period 118 can simply specify the registration time 501, the effective period termination time 505, and the update waiting period 506, and may be stored as other different type of information like time or period. The update starting time in this embodiment is the time starting the communication by means of the IKE protocol.

The database management device 401 in the embodiment 2 further comprises effective period management means 402. The effective period management means 402 stores effective period management information 410 to 414 corresponding to each SA1 to SA5 respectively. The effective period management information 410 to 414 stores address information (pointer) of corresponding SA1 to SA5 as the reference information, while storing the effective period termination time (505 in FIG. 5, for example) of corresponding SA1 to SA5 as the effective period termination time. The effective period management information is registered by the effective period management means 402 at the registration of the SA. The effective period management information 410 to 414 are stored in a form of event queue, and lined up in sequence of earlier of the effective period termination time. The reference information is not restricted to the pointer; it may be those capable of specifying and referring to the SA1 to SA5 like the entry number of database.

According to FIG. 4, the details of the processing of the effective period management means 402 will be explained hereafter. The event starter 403 comprising the effective period management means 402 receives from SAD control means 405 the information to the effect that the SA1 has been prepared, and then stores the effective period management information 410 corresponding to the SA1 in the effective period management means 402. The content of the effective period management information is as described above, while the effective period termination time is calculated by using the registration time 116 and the effective period 117 that were stored in the SA1 at the registration. After that, the effective period management means stores the effective period management information 411 to 413 regarding SA2 to SA4 in the same way.

Next, after the effective period management information 410 was stored, the effective period termination time comprising the effective period management information 410 is read by the event starter. The event starter 403 sets the effective period termination information in timer 404.

The timer 404 is always monitoring the time. When the effective period termination time corresponding to the SA1 has come, the timer notifies the event starter 403 of it.

When receiving the notice, the event starter 403 refers to the effective period management information 410 and reads out the reference information of the SA1. While transmitting the reference information to the SAD control means 405, the event starter 403 sets in the timer 404 the effective period management information 411 corresponding to the next SA2.

At receiving the reference information, the SAD control means 405 deletes the SA1 on the basis of the reference information. At the same time, the SAD control means may prepare and register the SA5 as a following SA corresponding to the SA1.

As described above, in the prior arts the SA couldn't be prepared, registered or deleted if a packet relevant to the SA is not inputted or outputted at a specific time. However, the invention added with a function for managing the effective period of SA can be sure to perform necessary processing like the preparation, the registration, or the deletion of SA. Since the invention does not fail to perform necessary processing, it is possible to avoid delaying the searching speed and a waste of the storage area of SAD due to neglect of unnecessary SA.

Besides, the invention is arranged that the relevant information described in the embodiment 1 be added to each SA in the embodiment 2, and the relevant information searching means 106 and the relevant information adding means 105 comprising the SAD control means 104 be provided with the SAD control means 405; thereby it is possible to improve the searching speed of SA further more.

### EMBODIMENT 3

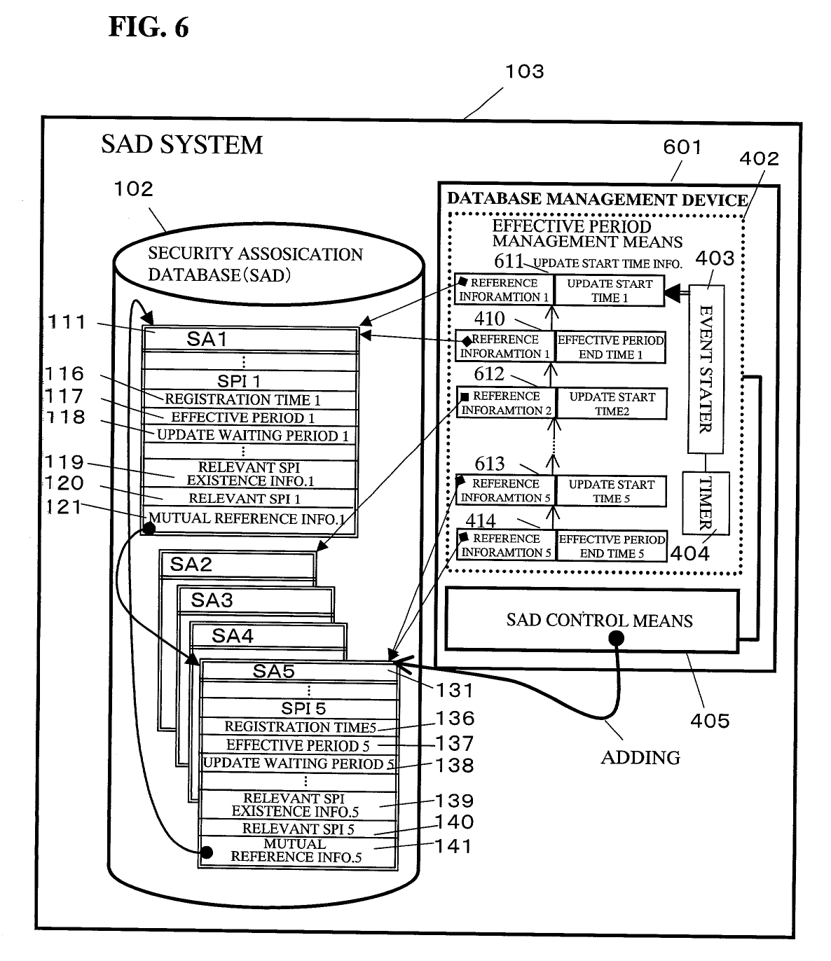

The database management device 601 in the embodiment 3 is explained here according to FIGS. 5 and 6. Besides, the database management device 601 of the embodiment 3 has many parts shared with that of the embodiment 1 and embodiment 2, so that only the different parts are explained hereafter. Each SA (SA1 to SA5) stored in the SAD 102 stores the registration time 116, 136, the effective period 117, 137, and the update waiting period 118, 138, respectively. However, the relevant information, such as the relevant SPI existence information, the relevant SPI, the mutual reference information, or the like as described in the embodiments 1 and 2 is not always necessary.

The database management device 601 of the embodiment 3 comprises the effective period management means 402 described in embodiment 2. However, in the effective period management means 402, the update start time information 611 to 613 are stored in addition to the effective period management information 410 to 414. The update start time information 611 to 613 stores address information (pointer) of the corresponding SA1 to SA5 as the reference information, while storing the time of starting the update (506 in FIG. 5) of the corresponding SA1 to SA5 as the update start time. Besides, the information is registered in the effective period management means 402 at the registration of SA. Supposed that the update start time information 611 to 613 are stored in a form of an event queue, and lined up in order in which the update start time and the effective period termination time are earlier. That is to say, the effective period management information relevant to the SA1 is stored next to the update start time information 611 relevant to the SA1, for example.

With reference to FIG. 6, the processing of the effective period management means 402 will be explained in detail.

The event starter 403 comprising the effective period management means 402 receives from SAD control means 405 the information to the effect that the SA1 has been prepared, and then stores the update start time information 611 corresponding to the SA1 in the effective period management means 402. In addition, the effective period management information 410 is stored in the effective period management means 402.

The update start time should be calculated by using the registration time 116, the effective period 117, and the update waiting period 118 that were stored in the SA1 at the registration. After that, regarding SA2 to SA4 the update start time information 611 to 613 and the effective period management information 411 to 413 are stored in the same way.

Next, after the update start time information 611 was stored, the update start time comprising the update start time information 611 is read by the event starter 403. The event starter 403 sets the update start time in the timer 404.

The timer 404 is always monitoring the time. When the update start time corresponding to the SA1 has come, the timer notifies the event starter 403 of it.

When receiving the notice, the event starter 403 refers to the update start time information 611 and reads out the reference information of the SA1. While transmitting the reference information to the SAD control means 405, the event starter 403 resets in the timer 404 the next effective period management information 410. Besides, the method that the effective period management means processes the effective period management information is the same as in the embodiment 2.

At receiving the reference information, according to the reference information the SAD control means 405 starts into negotiations by means of IKE protocol in order in which SA5 of a following SA corresponding to SA1 is prepared and registered. However, the negotiation may be executed by other means utilized by the IPSEC communication. In this case, the SAD control means 405 transmits the information of SA1 to other means and instructs said means to start into negotiation.

Supposed that the SAD control means 405 starts into negotiations. After the negotiation, SA5 is prepared. The SAD control means 405 stores the time of the preparation and registration of the SA5 (131) in the registration time 136 of the SA5 (131). Moreover, the predetermined effective period 137 and update waiting period 138 are also stored together. Next, the prepared information is notified to the effective period management means 402, and the effective period management means 402 registers the update start time information 613 relevant to the SA5.

In addition, the SAD control means 405 stores respective information in relevant information described in the embodiment 1, such as the relevant SPI existence information 119, 139, the relevant SPI 120, 140, and the mutual reference information 121, 141. At the same time, the searching order of the SA1 (111) may be exchanged with that of the SA5 (131). The details of this exchanging should be omitted because it depends on the searching method of SAD.

In the next place, when the effective period termination time stored in the effective period management information 410 has come, the effective period management means 402 notifies the SAD control means 405 of it, and then the SAD control means 405 deletes SA1 (111) on the basis of the reference information stored in the effective period management information 410. At the time of this deletion, while the relevant SPI existence information 139 of the relevant SA5 (131) is overwritten to “invalid”, the contents of the relevant SPI 140 and the mutual reference information 141 are deleted.

As described above, the invention of this embodiment is arranged so as to manage the update start time 506 exactly, and be sure to start into the negotiation by means of IKE protocol at the update start time, thereby even when the packet relevant to the SA1 is not sent or received, the following SA can be prepared and registered accurately. Since there is a sufficient time for the update waiting period, either one of SA1 or the following SA5 can always exist in the state of “valid”. It is possible to certainly do away with the delay of the communication for the registration.

Since there is a sufficient time, SA1 can exist for a while even after the preparation and the registration of SA5 of the post SA, and thereby when the IPSEC packet applying the SA1 arrives late because of the delay of the network, it is possible to process the packet normally without abandonment. This system can process all packets without problem, particularly in case of sending or receiving the real-time video for hours. Since the following SA or the original SA can be searched quickly on the basis of the relevant information, it is possible to avoid generating any blank or any disturbance in the received video.

Besides the update start time information 611 to 613 relevant to the preparation of the following SA may be processed in batch by the update management means involving the same function as the effective management means.

### EMBODIMENT 4

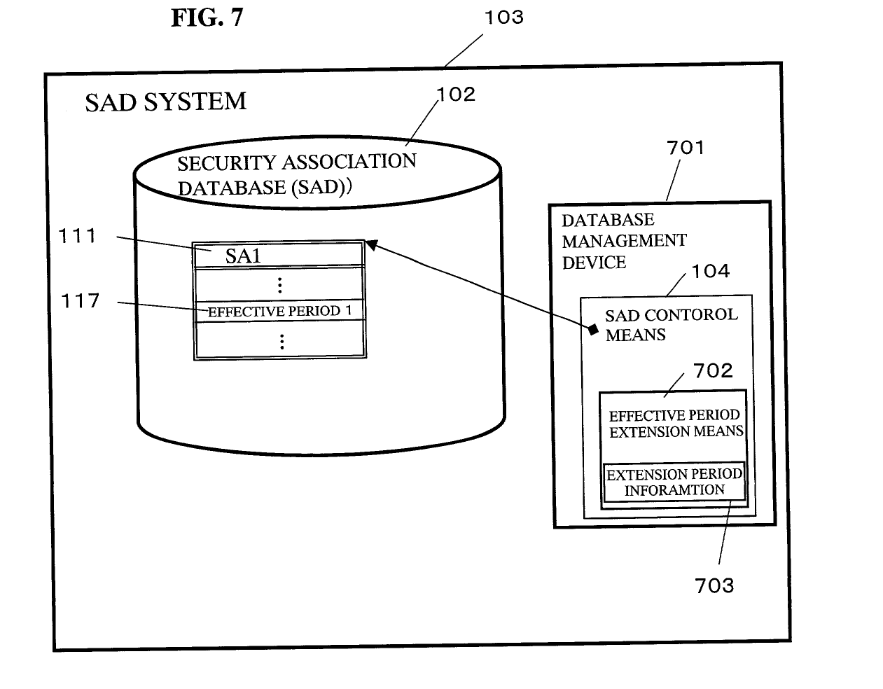

The database management device 701 in the embodiment 4 will be explained here according to FIG. 7. The database management device 701 in the embodiment 4 has many parts common to that in the embodiments 1 to 3, accordingly the following is the explanation regarding different parts.

In the embodiment 4, the database management device 701 is provided with effective period extension means 702 in the SAD control means 104. The effective period extension means 702 stores the extension period information 703.

Although the SAD control means 104 has searched SA1 (111), if the information of effective period 117 composing the SA1 (111) is that the period had expired, the effective period extension means 702 regards as a provisional effective period a value adding the information of effective period 117 and the extension period information 703, and then determines the effective period of SA1 (111) on the basis of the provisional effective period.

When the time searched by the SAD control means 104 is within the provisional effective period, the SA1 (111) is determined to be valid and then the packet is coded or decoded by means of the SA1.

Generally, when the packet is outputted from the sending terminal just before the effective period expires, the effective period of SA has expired before the packet arrives at the receiving terminal. In result, the packet is abandoned. However, since the effective period extension means is provided in the database management device, the packet to be abandoned in the usual way is not to be abandoned and can be utilized.

Besides, the extension period information may be provided independently per communication destination with due regard to the network structure or the traffics with a terminal to be a communication destination, and thereby it is possible to configure the invention according to the communication conditions.

### EMBODIMENT 5

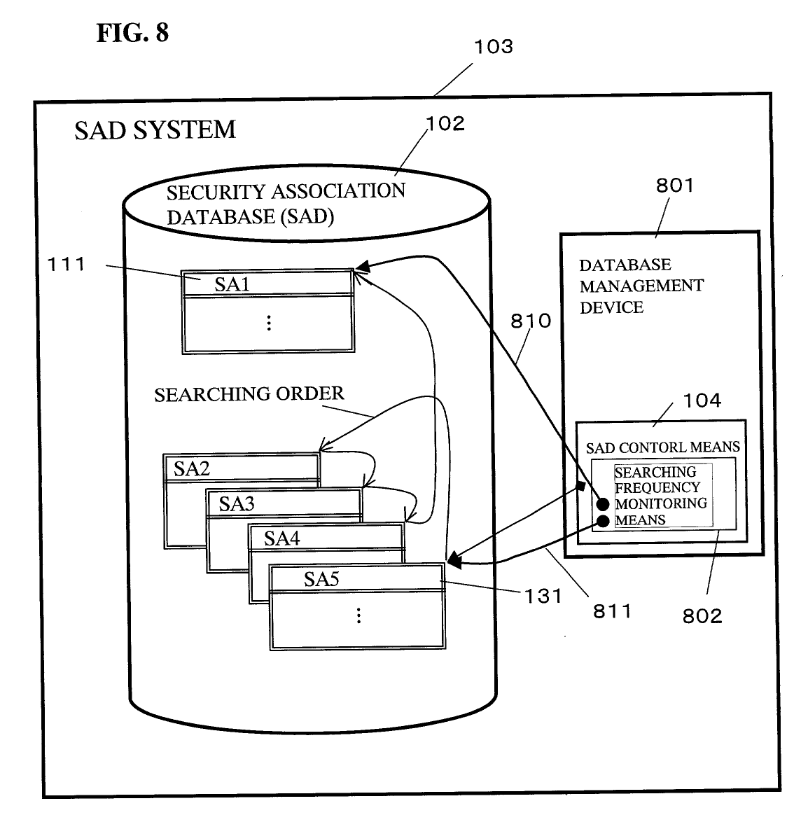

The database management device 801 in the embodiment 5 will be explained here according to FIG. 1 and FIG. 8. The database management device 801 in the embodiment 5 has many parts common to that in the embodiments 1 to 4, accordingly the following is the explanation regarding different parts. Regarding FIG. 1, the searching order only is to be referenced.

The database management device 801 in the embodiment 5 may comprises search frequency monitoring means 802. In addition, the search frequency monitoring means 802 stores the reference information between SA1 of which the update start time has come and SA5 that gets to be the following SA after the effective period of SA has expired.

The processing for the period after the update start time of the SA1 has come and before the effective period of the SA1 has not expired, for the period 510 shown in FIG. 5, will be explained hereafter. Supposed that the following SA of SA1 (111) be SA5 (131).

The search frequency monitoring means 802 recognizes by the processing of the update stating time that the SA5 (131) is the SA relevant to the SA1 (111), and then starts to count both searching frequencies of SA1 and of SA5. In the next place, SA with the high searching frequencies is determined at predetermined specific time interval. After that, the searching order is changed according to the reference information 810 and 811: for example, the searching order of SA5 (131) is changed from that shown in FIG. 1 to that shown in FIG. 8. That is to say, the searching order is to be changed to “SA5→SA2→SA3 →SA4→SA1”, instead of “SA1→SA2→SA3→SA4→SA5”. The details about the searching order change depend on the searching method of SAD; therefore it is not described here.

In the embodiment 5, the SA with the high searching frequencies is set as the prior searching order, however, it may be arranged that the SA5, which is SA after the effective period of SA1, be set as the prior searching order regardless of the searching frequencies.

As described above, for the period for searching both a following SA (SA5) and the SA(SA1) corresponding to the following SA, the searching order of the SA with the high searching frequency out of the both SA is set in order in which the searching time is short; thereby the SA with the high searching frequency can be searched in a short time.

1. A database management device managing information comprising required matters including an effective period as one data unit and preparing following data corresponding to the data when the effective period of the data expires, which comprising:
relevant information adding means for adding relevant information mutually associated with the data to both or either one of a specific data of which effective period expires and/or a following data corresponding to the specific data.

2. A database management device according to claim 1, which further comprising:
relevant information searching means for searching corresponding data referring to the relevant information including the data at the time of referring to the specific data or the following data.

3. A database management device according to claim 2, wherein the data is the information to carry out the security communication on a network and the effective period is that of the information.

4. A database management device according to claim 3, wherein the information to carry out the security communication contains either one of an authentication algorithm, an encryption algorithm, an authentication key, or an encryption key.

5. A database management device according to claim 4, wherein the data is SA (Security Association) applied to the IPSEC (Internet Protocol Security Protocol) Communication.

6. A database management device managing information comprising required matters including an effective period as one data unit and preparing following data corresponding to the data when the effective period of the data expires, which comprising:
effective period management means for storing the effective period and the reference information of data including the effective period associating each other and notifying of the expiration when the effective period expires; and
data control means for performing on the data specific processing due to the expiration of the effective period at receiving the notice from the effective period management means.

7. A database management device according to claim 6, wherein the specific processing is to prepare the corresponding following data.

8. A database management device according to claim 6, wherein the specific processing is to delete the data of which effective period expires.

9. A database management device according to claim 6, in which the information containing the required matters includes the time information to prepare the following data before the effective period expires, which further comprising:
update management means for storing the time information and the reference information of data including the time information associating each other and notifying to the effect that the time indicated by the time information has come; and
the data control means prepares the following data at receiving the notice from the update management means.

10. A database management device according to claim 6 or claim 9, which comprising:
relevant information adding means for adding the relevant information associated with the data each other to both or either one of a specific data of which effective period expires and/or the following data corresponding to the specific data.

11. A database management device according to claim 10, which comprising:
effective period extension means for storing the extension period information to extend the effective period and renewing the effective period of data of which effective period expires to the period indicated by the extension period information when the effective period expires.

12. A database management device according to claim 6 or claim 9, which comprising;
searching order management means for setting the searching order of the following data in front of the data corresponding to the following data.

13. A database management device according to claim 6 or claim 9, which further comprising:
searching frequency monitoring means for monitoring the searching frequency of the following data and the data corresponding to the following data; and
the searching order management means changes the searching orders of the specific data and the following data according to the searching frequency.

14. A database management device according to claim 6, wherein the data is information to carry out the security communication on a network, and the effective period is that of the information.

15. A database management device according to claim 14, wherein the information to carry out the security communication contains either one of an authentication algorithm, an encryption algorithm, an authentication key, or an encryption key.

16. A database management device according to claim 15, wherein the data is SA (Security Association) applied to the IPSEC (Internet Protocol Security Protocol).

17. A database management method of managing information comprising required matters including an effective period as one data unit and preparing following data corresponding to the data when the effective period of the data expires, which comprising the steps of:
adding relevant information mutually associated with the data to both or either one of a specific data of which effective period expires and/or a following data corresponding to the specific data; and
searching corresponding data referring to the relevant information including the data at the time of referring to the specific data or the following data.

18. A database management method of managing information comprising required matters including an effective period as one data unit and preparing following data corresponding to the data when the effective period of the data expires, which comprising the steps of:
storing the effective period and the reference information of data including the effective period associating each other and notifying of the expiration when the effective period expires; and
performing on the data specific processing due to the expiration of the effective period at receiving the notice.

19. A computer readable storage medium storing a program for executing a computer for managing information comprising required matters including an effective period as one data unit and preparing following data corresponding to the data when the effective period of the data expires, which comprising the steps of:
adding relevant information mutually associated with the data to both or either one of a specific data of which effective period expires and/or a following data corresponding to the specific data; and
searching corresponding data referring to the relevant information including the data at the time of referring to the specific data or the following data.

20. A computer readable storage medium storing a program for executing a computer for managing information comprising required matters including an effective period as one data unit and preparing following data corresponding to the data when the effective period of the data expires, which comprising the steps of:
storing the effective period and the reference information of data including the effective period associating each other and notifying of the expiration when the effective period expires; and
performing on the data specific processing due to the expiration of the effective period at receiving the notice.
